(19) United States
(12) Patent Application Publication
(10) Pub. No.: US 2015/0372764 A1
(43) Pub. Date: Dec. 24, 2015

(54) OPTICAL RECEIVER HAVING AN EQUALIZATION FILTER WITH AN INTEGRATED SIGNAL RE-SAMPLER

(71) Applicant: Alcatel-Lucent USA Inc., Murray Hill, NJ (US)

(72) Inventor: Noriaki Kaneda, Westfield, NJ (US)

(21) Appl. No.: 14/308,756

(22) Filed: Jun. 19, 2014

(51) Int. Cl. H04B 10/61

(52) U.S. Cl. CPC H04B 10/61

(57) ABSTRACT

We disclose an optical receiver having a digital filter with an integrated signal re-sampler that enables the receiver to both equalize and re-sample the digital signals generated by the receiver's ADCs configured to run at a fractional sampling frequency. In an example embodiment, the digital filter performs both signal equalization and signal interpolation in the frequency domain by applying an appropriate discrete spectral transfer function to a fractionally oversampled signal and then zero-padding the resulting equalized set of spectral samples. The digital filter re-samples the signal by applying an inverse Fourier transform to the zero-padded set of spectral samples and then truncating and decimating the resulting interpolated set of time-domain samples.

### BACKGROUND

1. Field

The present disclosure relates to optical communication equipment and, more specifically but not exclusively, to an optical receiver having an adaptive equalizer with an integrated signal re-sampler compatible with a fractional sampling rate.

2. Description of the Related Art

This section introduces aspects that may help facilitate a better understanding of the disclosure. Accordingly, the statements of this section are to be read in this light and are not to be understood as admissions about what is in the prior art or what is not in the prior art.

Digital-signal-processing (DSP)-based coherent (intradyne or homodyne) detection of optical communication signals is widely used in optical transport systems. Application-specific integrated circuits (ASICs) developed for this purpose often require relatively high power consumption, which impedes the development of commercially viable optical transceivers suitable for data rates higher than about 100 Gb/s. One possible approach to reducing power consumption in such ASICs would be to reduce the sampling rate of analog-to-digital converters (ADCs) employed therein. Under this approach, the conventionally used 2-times oversampling would need to be changed, e.g., to a 1·P-times oversampling, where P is a decimal fractional value smaller than one. However, digital circuits and signal-processing algorithms that can be used for this purpose are not sufficiently developed yet.

### SUMMARY OF SOME SPECIFIC EMBODIMENTS

Disclosed herein are various embodiments of an optical receiver having a digital filter with an integrated signal re-sampler that enables the receiver to both equalize and re-sample the digital signals generated by the receiver's ADCs running at a fractional sampling frequency. In an example embodiment, the digital filter performs both signal equalization and signal interpolation in the frequency domain by applying an appropriate discrete spectral transfer function to a fractionally oversampled signal and then zero-padding the resulting equalized set of spectral samples. The digital filter re-samples the signal by applying an inverse Fourier transform to the zero-padded set of spectral samples and then truncating and decimating the resulting interpolated set of time-domain samples. An embodiment of the optical receiver configured to oversample the input signal by a factor of 1.2 may advantageously be capable of providing approximately the same bit error rate as a comparable conventional optical receiver configured to oversample the input signal by a factor of 2.

According to one embodiment, provided is an apparatus comprising: an optical-to-electrical converter configured to mix an optical input signal and an optical local-oscillator signal to generate, at a first clock rate, a plurality of electrical digital measures of the optical input signal; and a digital processor that comprises a first digital filter configured to perform, in a frequency domain, both signal-equalization and signal-interpolation processing on a first set of digital values to generate a second set of digital values, said first set of digital values being generated using the plurality of electrical digital measures and being received by the first digital filter at the first clock rate, and said second set of digital values being outputted by the first digital filter at a second clock rate that is smaller than the first clock rate, wherein: a ratio of the first clock rate to the second clock rate is a non-integer value; and the digital processor is configured to recover data encoded in the optical input signal based on the second set of digital values.

According to another embodiment, provided is a signal-processing method comprising the steps of: optically mixing an optical input signal and an optical local-oscillator signal to generate, at a first clock rate, a plurality of electrical digital measures of the optical input signal; performing in a frequency domain both signal-equalization and signal-interpolation processing on a first set of digital values to generate a second set of digital values, said first set of digital values being generated using the plurality of electrical digital measures and being received by the digital circuit at the first clock rate, and said second set of digital values being outputted by the digital circuit at a second clock rate that is smaller than the first clock rate, wherein a ratio of the first clock rate to the second clock rate is a non-integer value; and recovering data encoded in the optical input signal based on the second set of digital values.

### BRIEF DESCRIPTION OF THE DRAWINGS

Other aspects, features, and benefits of various disclosed embodiments will become more fully apparent, by way of example, from the following detailed description and the accompanying drawings, in which:

FIG. 1 shows a block diagram of a coherent optical receiver according to an embodiment of the disclosure;

FIG. 2 shows a block diagram of a digital circuit that can be used in the optical receiver of FIG. 1 according to an embodiment of the disclosure;

FIG. 3 shows a block diagram of an equalization filter that can be used in the digital circuit of FIG. 2 according to an embodiment of the disclosure;

FIG. 4 shows a block diagram of an electronic filter controller that can be used in conjunction with the equalization filter of FIG. 3 according to an embodiment of the disclosure; and

FIG. 5 shows a block diagram of an equalization filter that can be used in the digital circuit of FIG. 2 according to an alternative embodiment of the disclosure.

### DETAILED DESCRIPTION

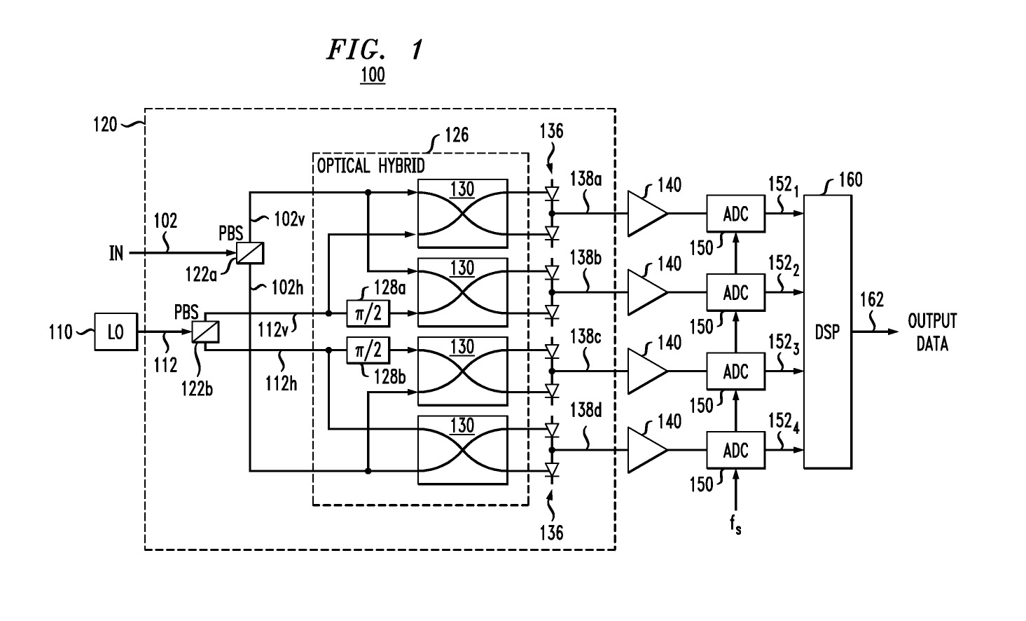

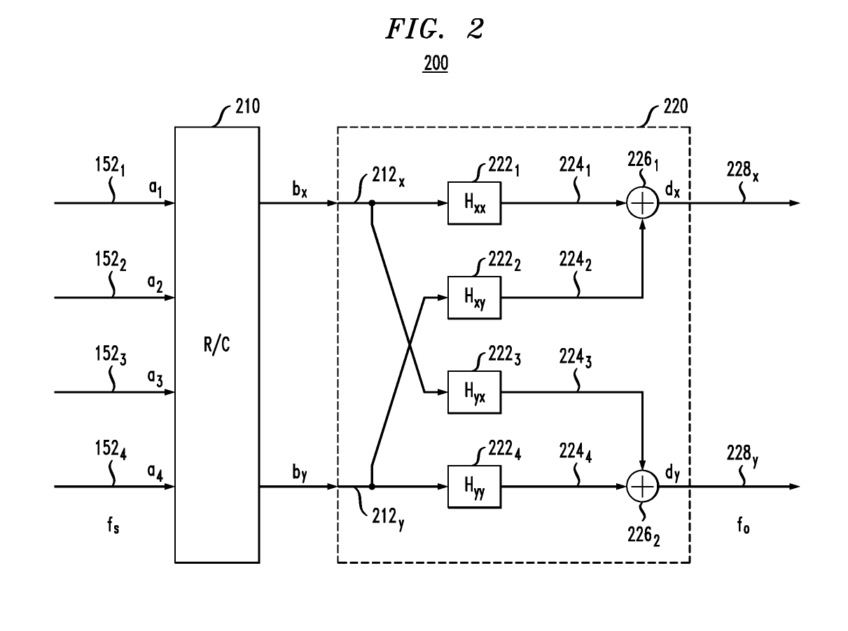

FIG. 1 shows a block diagram of a coherent optical receiver 100 according to an embodiment of the disclosure. Receiver 100 receives an optical polarization-division multiplexed (PDM) input signal 102, e.g., from a remote transmitter, via an external optical transport link (not explicitly shown in FIG. 1). Optical input signal 102 is applied to an optical-to-electrical (O/E) converter 120 that converts that optical signal into four analog electrical signals 138a-138d. Each of signals 138a-138d may be amplified in a corresponding amplifier 140 coupled to a corresponding analog-to-digital (A/D) converter (ADC) 150. Each A/D converter 150 samples the output of the corresponding amplifier 140 at a selected fractional sampling frequency (ƒₛ) to produce a corresponding one of four digital electrical signals 152₁-152₄. Digital signals 152₁-152₄ are applied to a digital signal processor (DSP) 160 that processes them, e.g., as described in more detail below in reference to FIGS. 2-4, to recover the data streams originally encoded onto the PDM components of optical input signal 102 at the remote transmitter. DSP 160 then outputs the recovered data streams via an output signal 162.

In an example embodiment, sampling frequency ƒₛ can be expressed as follows:

ƒₛ=M/(NT) (1)

where M and N are positive integers greater than one; T is the symbol period in optical input signal 102; and M>N. In some embodiments, M/N<2 and, as such, can be expressed as M/N=1·P, where P is a decimal fractional value smaller than one. In some embodiments, the value of M/N is in the range between about 1.05 and about 1.35.

In one embodiment, receiver 100 may include a set of electrical low-pass filters (not explicitly shown in FIG. 1), each inserted between O/E converter 120 and the respective one of A/D converters 150. The use of these filters may help to reduce noise and prevent aliasing.

O/E converter 120 implements a polarization-diversity intradyne-detection scheme using an optical local-oscillator (LO) signal 112 generated by an optical LO source 110. Polarization beam splitters (PBSs) 122a and 122b decompose signals 102 and 112, respectively, into two respective orthogonally polarized components, illustratively vertically polarized components 102v and 112v and horizontally polarized components 102h and 112h. These polarization components are then directed to an optical hybrid 126.

In optical hybrid 126, each of polarization components 102v, 112v, 102h, and 112h is split into two (attenuated) copies, e.g., using a conventional 3-dB power splitter (not explicitly shown in FIG. 1). A relative phase shift of about 90 degrees (π/2 radian) is then applied to one copy of component 112v and one copy of component 112h using phase shifters 128a-128b, respectively. The various copies of signals 102v, 112v, 102h, and 112h are optically mixed with each other as shown in FIG. 1 using four optical signal mixers 130, and the mixed optical signals produced by the mixers are detected by eight photo-detectors (e.g., photodiodes) 136. Photo-detectors 136 are arranged in pairs, as shown in FIG. 1, and the output of each photo-detector pair is a corresponding one of electrical signals 138a-138d. This configuration of photo-detectors 136 is a differential configuration that helps to reduce noise and improve DC balancing. In an alternative embodiment, O/E converter 120 can have four photo-detectors 136, one per optical signal mixer 130, configured for single-ended detection of the corresponding optical signals.

Example optical hybrids that are suitable for use in optical receiver 100 are disclosed, e.g., in U.S. Patent Application Publication Nos. 2007/0297806 and 2011/0038631, both of which are incorporated herein by reference in their entirety.

In an example embodiment, DSP 160 is configured to perform signal equalization and carrier- and data-recovery processing. Signal equalization is generally directed at reducing the detrimental effects of various signal impairments imparted onto the received optical signal in the optical transport link. Such signal impairments may include, but are not limited to chromatic dispersion, polarization distortion or rotation, polarization-mode dispersion (PMD), additive noise, and spectral distortion. One of ordinary skill in the art will appreciate that these signal impairments might accrue in the optical link through either localized or distributed mechanisms, or through a combination of both types of mechanisms. The carrier- and data-recovery processing is generally directed at reducing the detrimental effects of the frequency mismatch between the carrier frequencies of optical LO signal 112 and input signal 102, phase noise, and/or local-oscillator phase error to enable receiver 100 to recover the transmitted data with a relatively low bit error rate (BER). Description of the additional signal processing that may be implemented in DSP 160 according to various embodiments of the disclosure can be found, e.g., in U.S. Patent Application Publication Nos. 2013/0230312 and 2014/0086594, and U.S. patent application Ser. No. 13/729,403 (attorney docket ref. 812179-US-NP, filed on Dec. 28, 2012), all of which are incorporated herein by reference in their entirety.

Ideally, digital signals 152₁-152₂ represent the I and Q components, respectively, of the first PDM (e.g., X-polarized) component of the original optical communication signal generated by the remote transmitter, and digital signals 152₃-152₄ represent the I and Q components, respectively, of the second PDM (e.g., Y-polarized) component of that optical communication signal. However, the often-present misalignment between the principal polarization axes of the remote transmitter and the principal polarization axes of receiver 100 and polarization rotation in the optical fiber generally cause each of digital signals 152₁-152₄ to be a convoluted signal that has signal distortions and/or contributions from both of the original PDM components. The train of signal processing implemented in DSP 160 is generally directed at de-convolving digital signals 152₁-152₄ and also reducing the effects of various signal impairments and distortions so that the encoded data can be recovered for output signal 162 with an acceptably low BER.

FIG. 2 shows a block diagram of a digital circuit 200 that can be used in DSP 160 (FIG. 1) according to an embodiment of the disclosure. For illustration purposes, digital circuit 200 is shown in FIG. 2 as being configured to receive digital signals 152₁-152₄ (also see FIG. 1). Alternative configurations of digital circuit 200 are also contemplated, including those corresponding to possible uses of this digital circuit in devices different from optical receiver 100.

For example, digital circuit 200 can be configured to receive digital input signals that have been generated by preprocessing digital signals 152₁-152₄. One possible type of preprocessing may be directed at compensating various orthogonality-degrading effects (also sometimes referred to as I/Q signal imbalance) imposed by O/E converter 120. Such preprocessing can advantageously be used, e.g., to relax the specification requirements to some opto-electronic circuits used in receiver 100, thereby potentially providing significant cost savings for the manufacturer and/or operator of the corresponding optical-transport system. Other suitable types of preprocessing may also be used to condition digital signals 152₁-152₄ prior to their application to digital circuit 200.

Digital circuit 200 comprises a real-to-complex (R/C) converter 210 configured to perform signal transforms expressed by Eqs. (2a) and (2b):

bₓ=a₁+ja₂ (2a)

b_{y}=a₃+ja₄ (2b)

where a₁, a₂, a₃, and a₄ are the real-valued components of an input vector A=(a₁,a₂,a₃,a₄) provided by digital signals 152₁-152₄; and bₓ and b_{y} are the corresponding pair of complex values generated by R/C converter 210. Note that input vector A is refreshed at clock frequency ƒₛ (see Eq. (1)) because the latter is the clock rate of A/D converters 150, which generate digital signals 152₁-152₄ (see FIG. 1). Accordingly, R/C converter 210 outputs a new pair of complex values bₓ and b_{y} every clock cycle of clock frequency ƒₛ.

Digital circuit 200 further comprises an equalizer circuit 220 configured to receive, via digital signals 212x and 212y, streams of complex values bₓ and b_{y} at clock rate ƒₛ. Equalizer 220 is further configured to generate, based on digital signals 212x and 212y, complex-valued digital signals 228x and 228y that have a clock rate ƒ₀ (=1/T), where T is the symbol period in optical input signal 102. As such, in addition to signal-equalization processing, equalizer circuit 220 performs signal interpolation and re-sampling from clock rate ƒₛ (=Mƒ₀/N) to clock rate ƒ₀ (=1/T). One of ordinary skill in the art will understand that clock rate ƒ₀ is also the symbol rate of optical input signal 102.

In the embodiment shown in FIG. 2, equalizer circuit 220 comprises equalization filters 222₁-222₄ connected in a butterfly configuration. One of ordinary skill in the art will appreciate that other filter configurations may also be used in alternative embodiments of equalizer circuit 220. The number of equalization filters 222 or their functional analogs in such alternative embodiments of equalizer circuit 220 may differ from four.

Equalizer circuit 220 is configured to mix complex-valued digital signals 212x and 212y, using equalization filters 222₁-222₄ and adders 226₁ and 226₂, to convert those signals into complex-valued digital signals 228x and 228y in accordance with Eqs. (3a) and (3b):

X′=Hₓₓ*X+H_{xy}*Y (3a)

Y′=H_{yx}*X+H_{yy}*Y (3b)

where X′ is a string of complex values dₓ in signal 228x; Y′ is a string of complex values d_{y} in signal 228y; X is a string of complex values bₓ in signal 212x; Y is a string of complex values b_{y} in signal 212y; the “*” symbol denotes the convolution operation; and Hₓₓ, H_{xy}, H_{yx}, and H_{yy} are the transfer functions of equalization filters 222₁-222₄, respectively. Strings X′ and Y′ have equal lengths. Strings X and Y also have equal lengths. However, due to the re-sampling performed in equalizer circuit 220, the length of strings X′ and Y′ is smaller than the length of strings X and Y.

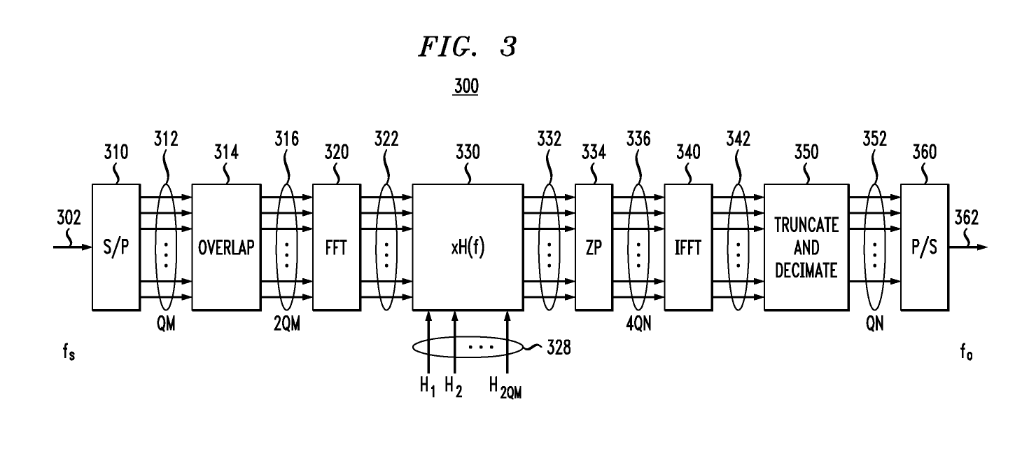

In one embodiment, the individual transfer functions of equalization filters 222₁-222₄ may be configured to cause equalizer circuit 220 to perform polarization de-multiplexing. For example, equalizer circuit 220 may be configured to generate signals 228x and 228y such that: (i) signal 228x represents a first original PDM component generated at the remote transmitter with as little crosstalk from a second original PDM component generated at the remote transmitter as practically possible, and (ii) signal 228y represents the second original PDM component with as little crosstalk from the first PDM component as practically possible. Polarization de-multiplexing may be used to undo, to a significant extent, the PDM-component mixing caused by (i) the usually present misalignment between the principal polarization axes of the remote transmitter and the principal polarization axes of receiver 100 and (ii) polarization rotation imposed onto optical input signal 102 in the optical fiber between the remote transmitter and receiver 100. In some embodiments, each individual equalization filter 222 can be implemented using an interpolating frequency-domain-equalization (IFDE) filter, an example embodiment of which is described in more detail below in reference to FIG. 3.

Complex-valued digital signals 228x and 228y generated by equalizer circuit 220 are further processed in DSP 160 (FIG. 1) to generate output signal 162. This further processing may include but is not limited to additional equalization processing, carrier and phase recovery, constellation mapping, data decoding, and error correction.

FIG. 3 shows a block diagram of an IFDE filter 300 that can be used to implement any of equalization filters 222₁-222₄ in digital circuit 200 (FIG. 2) according to an embodiment of the disclosure. Filter 300 is shown in FIG. 3 as being configured to receive an input signal 302 and to generate a filtered output signal 362. Signals 302 and 362 have clock rates ƒₛ and ƒ₀, respectively. When filter 300 is used as equalization filter 222, input signal 302 is one of digital signals 212x and 212y, and filtered output signal 362 is one of digital signals 224₁-224₄ (also see FIG. 2). In some embodiments, digital circuit 200 may have four instances (copies) of filter 300, each disposed in place of one of equalization filters 222₁-222₄.

Filter 300 has a serial-to-parallel (S/P) converter 310 configured to generate a set 312 of QM complex digital values, e.g., by placing QM consecutive complex values b_{y} (where p=x or y) received via input signal 302, in the order of their arrival, into appropriate positions within set 312. The number QM of parallel lines in the bus connecting S/P converter 310 and an overlap module 314 is determined by the value of Q, which is a design parameter of filter 300. In an example embodiment, the value of Q may be selected such that the values of QM and QN are both integers, where 2N>M. In some embodiments, these conditions may be satisfied with a non-integer Q. In some embodiments, Q is a positive integer.

Overlap module 314 is configured to convert the set 312 received from S/P converter 310 into a set 316 of 2QM complex values, e.g., by prefixing QM complex values from the set 312 received from S/P converter 310 in the preceding processing round. A fast Fourier-transform (FFT) module 320 operates to apply a discrete Fourier transform to the set 316, thereby generating a set 322 of 2QM spectral samples, each being a complex value. A transfer-function-application module (×H(ƒ)) 330 then operates to apply a frequency-dependent transfer function H(ƒ) to the set 322 received from FFT module 320, thereby generating a modified (e.g., equalized) set 332 of 2QM spectral samples.

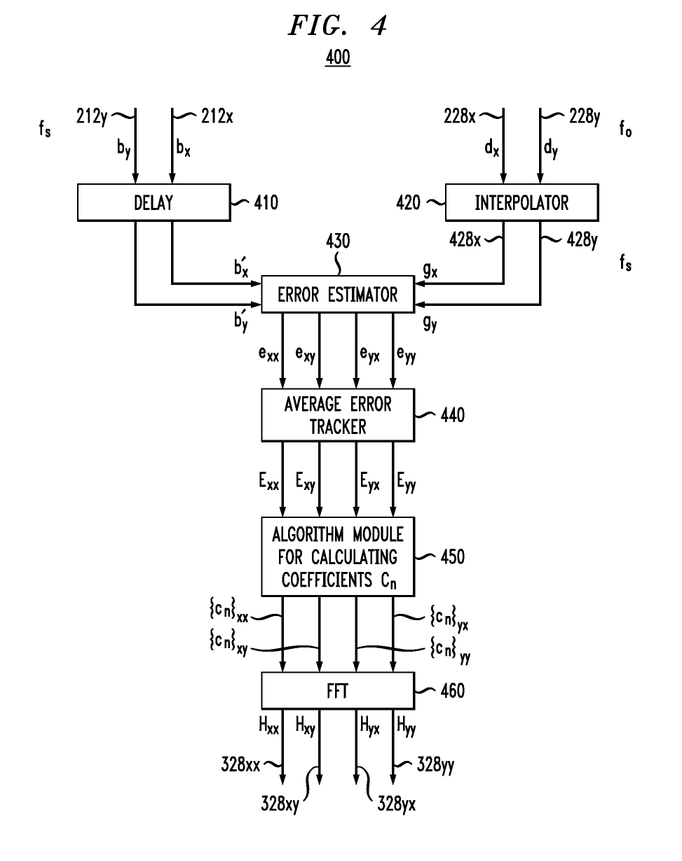

Transfer function H(ƒ) is a discrete function of frequency defined by a set 328 of 2QM complex values (H₁, H₂, . . . , H_{2QM}). An example embodiment of an electronic filter controller configured to generate a set 328 that can be used in transfer-function-application module 330 is described in more detail below in reference to FIG. 4. Transfer-function-application module 330 is configured to generate each component of the modified set 332 by multiplying the corresponding component of the set 322 and the corresponding component of the set 328.

A zero-padding (ZP) module 334 transforms the modified set 332 generated by transfer-function-application module 330 into an expanded set 336 of 4QN spectral samples by appending L=2Q(2N−M) zero-valued spectral samples to the end(s) of the modified set 332. One of ordinary skill in the art will understand that this zero-padding operation is a basis of signal interpolation, which is caused by the broadening of the spectral window corresponding to the modified set 332 in the frequency domain. The effect of this broadening is a corresponding reduction in the sample dwell time in the time domain.

An inverse-FFT (IFFT) module 340 operates to apply an inverse discrete Fourier transform to the expanded set 336 received from ZP module 334, thereby generating a set 342 of 4QN time-domain complex values. Recall that the sample dwell time corresponding to the set 316 received by FFT module 320 is 1/ƒₛ. In contrast, the sample dwell time corresponding to the set 342 generated by IFFT module 340 is 1/(2ƒ₀). As such, the complex values of the set 342 represent time-interpolated signal samples corresponding to the set 316. Of the of 4QN complex values in the set 342, the first 2QN complex values correspond to the QM samples prefixed to the set 312 in overlap module 314, and the second 2QN complex values correspond to the set 312 received in the current processing round by the overlap module.

A truncate-and-decimate module 350 is configured to transform the set 342 received from IFFT module 340 into an interpolated set 352 of QN complex values. Module 350 performs this transformation by (i) first removing from the set 342 the first 2QN complex values corresponding to the prefix and (ii) then decimating one of every two complex values in the remaining 2QN complex values of the set 342. A parallel-to-serial (P/S) converter 360 then serializes the interpolated set 352 generated by module 350, thereby generating a corresponding segment of equalized and interpolated output signal 362. As already indicated above, the clock rate of signal 362 is ƒ₀.

In an example embodiment, filter 300 is configured to operate by repeating the above-described sequence of operations on each set of QM complex values bₚ (where p=x or y) received via input signal 302, with said set of QM complex values bₚ being located within a time window having a duration corresponding to N symbol periods of optical input signal 102. The time window is slid forward by N symbol periods each time this sequence of operations is completed. When four instances of filter 300 are used in equalizer circuit 220 (FIG. 2), each of said instances may be configured to use a different respective frequency-dependent transfer function H(ƒ), e.g., to realize signal processing corresponding to Eqs. (3a) and (3b). In addition, each of these frequency-dependent transfer functions H(ƒ) may adaptively change over time, e.g., as described below in reference to FIG. 4.

In an alternative embodiment, overlap module 314 may be configured to convert the set 312 received from S/P converter 310 into a set 316 of (1+S)QM complex values, where S<1. In other alternative embodiments, overlap module 314 may be configured to use a combination of prefixing and suffixing in the process of generating set 316. In some other alternative embodiments, overlap module 314 may be configured to use suffixing instead of prefixing in the process of generating set 316. In all these alternative embodiments, the operation of truncate-and-decimate module 350 is modified accordingly as well.

FIG. 4 shows a block diagram of an electronic filter controller 400 that can be used to generate a discrete transfer function H(ƒ) for use in transfer-function-application module 330 of filter 300 (FIG. 3) according to an embodiment of the disclosure. More specifically, controller 400 is designed to generate four different discrete transfer functions H(ƒ) that can be used in four different filters 300 configured to operate as equalization filters 222₁-222₄, respectively, in digital circuit 200 (FIG. 2). In the nomenclature used in the description of FIG. 2, these four discrete transfer functions H(ƒ) are denoted as Hₓₓ, H_{xy}, H_{yx}, and H_{yy}, respectively (also see Eqs. (3a) and (3b)).

Controller 400 is designed to leverage functional equivalency between time-domain and frequency-domain implementations of a finite-impulse-response (FIR) filter. More specifically, for a conventional 2QM-tap FIR filter, the 2QM tap coefficients C₁-C_{2QM} used in the filter's time-domain implementation and the discrete transfer function H(ƒ)=(H₁, H₂, . . . , H_{2QM}) used in the filter's frequency-domain implementation are related via Eq. (4):

$$H ( f ) = {\sum }_{n = 1}^{2 QM} {C}_{n} {e}^{- 2 πj ( n - 1 ) fτ} \qquad ( 4 )$$

where ƒ is frequency, and τ is the tap delay. Eq. (4) suggests that a conventional time-domain algorithm used in the calculation of tap coefficients Cₙ for a time-domain FIR filter, such as a constant modulus algorithm (CMA) or a least mean square (LMS) algorithm, can be adapted for the calculation of the discrete transfer function H(ƒ) for filter 300. This approach is realized in controller 400 as further described below.

Controller 400 is configured to receive digital signals 212x, 212y, 228x, and 228y (FIG. 2). Based on these received signals, controller 400 generates digital signals 328xx, 328xy, 328yx, and 328yy (FIG. 3) as further described below. Digital signals 328xx, 328xy, 328yx, and 328yy are configured to provide discrete transfer functions Hₓₓ, H_{xy}, H_{yx}, and H_{yy}, respectively, for four instances of filter 300 configured to operate as equalization filters 222₁-222₄, respectively, in digital circuit 200 (FIG. 2).

Digital signals 228x and 228y are applied to an interpolator 420 configured to convert these digital signals, by interpolation, into digital signals 428x and 428y. Recall that digital signals 228x and 228y carry streams of complex values dₓ and d_{y}, respectively, at clock rate ƒ₀. The interpolation serves to increase the clock rate to ƒₛ by converting streams of dₓ and d_{y} into interpolated streams of complex values gₓ and g_{y}, respectively. Hence, digital signals 428x and 428y generated by interpolator 420 carry streams of complex values gₓ and g_{y}, respectively, at clock rate ƒₛ.

Digital signals 212x and 212y are applied to a delay element 410 configured to introduce a time delay that is approximately equal in duration to the combined latency of signal processing in filter 300 and interpolator 420. This time delay serves to appropriately align in time the different complex values corresponding to each other in the train of signal processing for proper error estimation in controller 400. The delayed complex values of digital signals 212x and 212y are denoted as bₓ′ and b_{y}′, respectively. Recall that the clock rate of digital signals 212x and 212y is ƒₛ, which matches the clock rate of digital signals 428x and 428y.

An error estimator 430 is configured to generate a set of error estimates eₘₗ, where m=x, y and l=x, y. For example, for a PDM-QPSK constellation, error estimator 430 can be configured to generate the set of error estimates eₘₗ as follows:

eₘₗ(k)=(1−|bₘ′(k)|²)bₘ′(k)gₗ*(k) (5)

where k is the counter of clock periods; bₘ′(k) is the value of delayed signal 212m in the k-th clock period; gₗ(k) is the value of signal 428l in the k-th clock period; and the “*” superscript denotes the complex conjugate.

An average error tracker 440 is configured to track average estimated errors Eₘₗ by recursively updating them based on the error estimates eₘₗ received from error estimator 430, for example, as follows:

Eₘₗ(k)=Eₘₗ(k−1)+μeₘₗ(k) (6)

where μ is an error-weighting coefficient. In an example embodiment, the value of μ is selected to be relatively small, e.g., on the order of 0.01, to avoid sudden excursions in the Eₘₗ values and ensure stable operation of controller 400.

The average estimated errors Eₘₗ calculated by error tracker 440 are provided to an algorithm module 450. As already indicated above, algorithm module 450 may be configured to apply an appropriate algorithm (e.g., CMA or LMS) to the received average estimated errors Eₘₗ to calculate four sets of coefficients Cₙ corresponding to the putative time-domain FIR filters corresponding to equalization filters 222₁-222₄ in digital circuit 200 (FIG. 2). These four sets of coefficients Cₙ are denoted in FIG. 4 as {Cₙ}ₓₓ, {Cₙ}_{xy}, {Cₙ}_{yx}, and {Cₙ}_{yy}, respectively. Each of the four sets has 2QM coefficients Cₙ.

An FFT module 460 operates to apply a discrete Fourier transform to the sets {Cₙ}ₓₓ, {Cₙ}_{xy}, {Cₙ}_{yx}, and {Cₙ}_{yy} received from algorithm module 450, thereby generating discrete transfer functions Hₓₓ, H_{xy}, H_{yx}, and H_{yy} in accordance with Eq. (4). Each of the discrete transfer functions Hₓₓ, H_{xy}, H_{yx}, and H_{yy} generated by FFT module 460 can then be used in the transfer-function-application module 330 of a respective one of four filters 300 (FIG. 3) employed in digital circuit 200 (FIG. 2).

Note that interpolator 420 functions to even the clock rates of the digital signals applied to error estimator 430. This function is implemented because signals 212x and 212y have the clock rate ƒₛ while signals 228x and 228y have the clock rate ƒ₀. In an alternative embodiment, this function can be implemented by, e.g., (i) inserting a first down-sampler between delay element 410 and error estimator 430, and (ii) replacing interpolator 420 by a second down-sampler. When the second down-sampler is configured to down-sample each of signals 228x and 228y by passing one of each N samples, and the first down-sampler is configured to down-sample each of signals 212x and 212y by passing one of each M samples, the resulting digital signals applied to error estimator 430 have the same clock rate of ƒₛ/M=ƒ₀/N. One of ordinary skill in the art will understand that other appropriate combinations of the down-sampling rates in the first and second down-samplers can similarly accomplish the task of equalizing the clock rates of the digital signals applied to error estimator 430.

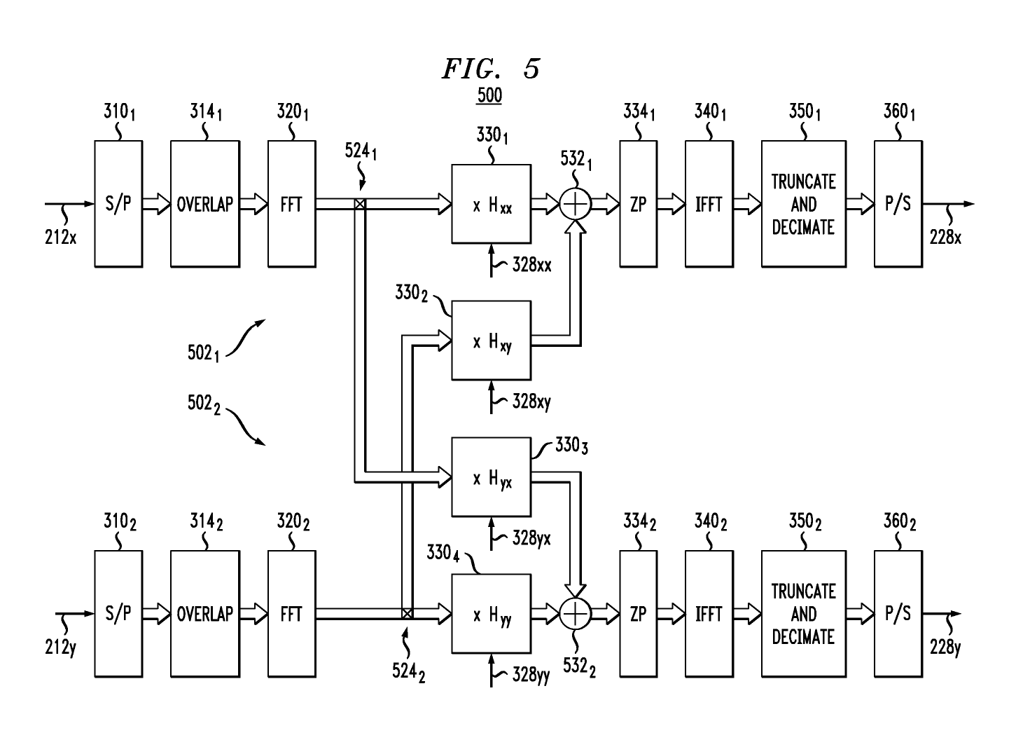

FIG. 5 shows a block diagram of an IFDE filter 500 that can be used to implement equalizer circuit 220 in digital circuit 200 (FIG. 2) according to an embodiment of the disclosure. Filter 500 is shown in FIG. 5 as being configured to receive digital signals 212x and 212y and to generate filtered digital signals 228x and 228y (also see FIG. 2). As already indicated above, signals 212x and 212y have the clock rate ƒₛ, and signals 228x and 228y have the clock rate ƒ₀. One of ordinary skill on the art will understand that alternative input/output signal configurations of filter 500 are also possible.

Filter 500 uses many of the same elements as filter 300. The labeling of these elements in FIG. 5 is the same as in FIG. 3, with the subscripts being added to the labels to designate different copies of the same element. For the description of the reused elements, the reader is referred to the above-provided description of FIG. 3. The following description of filter 500 focuses primarily on the differences between filters 300 and 500.

Filter 500 has two processing branches 502₁ and 502₂, each implementing the train of processing that is generally similar to that of filter 300. Processing branches 502₁ and 502₂ are interconnected through transfer-function-application modules 330₂ and 330₃ as indicated in FIG. 5. More specifically, a bus splitter 524₁ is configured to provide module 330₃ with a copy of the input applied to module 330₁ in processing branch 502₁. A bus splitter 524₂ is similarly configured to provide module 330₂ with a copy of the input applied to module 330₄ in processing branch 502₂. A bussed signal adder 532₁ is configured to sum, in a bus-line by bus-line manner, the digital outputs of modules 330₁ and 330₂ and apply the resulting summed spectral samples to zero-padding module 334₁ in processing branch 502₁. A bussed signal adder 532₂ is similarly configured to sum, in a bus-line by bus-line manner, the digital outputs of modules 330₃ and 330₄ and apply the resulting summed spectral samples to zero-padding module 334₂ in processing branch 502₂. In an example embodiment, modules 330₁-330₄ may be configured to apply the discrete transfer functions Hₓₓ, H_{xy}, H_{yx}, and H_{yy} generated by controller 400 and supplied to modules 330₁-330₄ via digital signals 328xx, 328xy, 328yx, and 328yy as indicated in FIG. 5 (also see FIG. 4).

According to an example embodiment disclosed above in reference to FIGS. 1-5, provided is an apparatus (e.g., 100, FIG. 1) comprising: an optical-to-electrical converter (e.g., 120, FIG. 1) configured to mix an optical input signal (e.g., 102, FIG. 1) and an optical local-oscillator signal (e.g., 112, FIG. 1) to generate, at a first clock rate (e.g., ƒₛ, Eq. (1) and FIG. 1), a plurality of electrical digital measures (e.g., 152₁-152₄, FIG. 1) of the optical input signal; and a digital processor (e.g., 160, FIG. 1; 200, FIG. 2), wherein: the digital processor comprises a first digital filter (e.g., one of 222₁-222₄, FIG. 2; 300, FIG. 3; 500, FIG. 5) configured to perform, in a frequency domain, both signal-equalization and signal-interpolation processing on a first set (e.g., 312, FIG. 3) of digital values to generate a second set (e.g., 352, FIG. 3) of digital values, said first set of digital values being generated using the plurality of electrical digital measures and being received by the first digital filter (e.g., via 302, FIG. 3) at the first clock rate, and said second set of digital values being outputted by the first digital filter (e.g., via 362, FIG. 3) at a second clock rate (e.g., ƒ₀, FIGS. 2, 3) that is smaller than the first clock rate; a ratio of the first clock rate to the second clock rate is a non-integer value (e.g., M/N); and the digital processor is configured to recover data encoded in the optical input signal based on the second set of digital values.

In some embodiments of the above apparatus, the second clock rate is nominally equal to a symbol rate of the optical input signal.

In some embodiments of any of the above apparatus, the non-integer value is smaller than 2.

In some embodiments of any of the above apparatus, the non-integer value is in a range between 1.05 and 1.35.

In some embodiments of any of the above apparatus, the ratio of the first clock rate to the second clock rate is a fraction M/N, where M and N are positive integers, and M>N.

In some embodiments of any of the above apparatus, the first set of digital values consists of QM complex values, where QM is a positive integer; and the second set of digital values consists of QN complex values, where QN is a positive integer.

In some embodiments of any of the above apparatus, Q is a non-integer value.

In some embodiments of any of the above apparatus, Q is an integer.

In some embodiments of any of the above apparatus, the first digital filter comprises: a Fourier-transform module (e.g., 320, FIG. 3) configured to apply a discrete Fourier transform to a third set (e.g., 316, FIG. 3) of digital values to generate a fourth set (e.g., 322, FIG. 3) of digital values, wherein the third set includes the first set; a transfer-function-application module (e.g., 330, FIG. 3) configured to apply a first discrete transfer function (e.g., one of Hₓₓ, H_{xy}, H_{yx}, and H_{yy}, Eqs. (3a)-(3b) and FIG. 4; 328, FIG. 3) to the fourth set of digital values to generate a fifth set (e.g., 332, FIG. 3) of digital values; a zero-padding module (e.g., 334, FIG. 3) configured to generate a sixth set (e.g., 336, FIG. 3) of digital values by appending a plurality of zeros to the fifth set of digital values; and an inverse Fourier-transform module (e.g., 340, FIG. 3) configured to apply an inverse discrete Fourier transform to the sixth set of digital values to generate a seventh set (e.g., 342, FIG. 3) of digital values, wherein the seventh set includes the second set.

In some embodiments of any of the above apparatus, the first digital filter further comprises an additional transfer-function-application module (e.g., 330₂, FIG. 5) configured to apply another discrete transfer function to the fourth set of digital values, said another discrete transfer function being different from the first discrete transfer function.

In some embodiments of any of the above apparatus, the apparatus further comprises an electronic filter controller (e.g., 400, FIG. 4) configured to generate the first discrete transfer function based on a sequence of first sets generated by the digital processor and a sequence of second sets generated by the first digital filter.

In some embodiments of any of the above apparatus, the electronic filter controller comprises an interpolator (e.g., 420, FIG. 4) configured to interpolate the second set of digital values to generate a corresponding interpolated set of digital values having more digital values than the second set, said corresponding interpolated set of digital values being carried by a digital signal (e.g., 428, FIG. 4) having the first clock rate.

In some embodiments of any of the above apparatus, the electronic filter controller comprises a second Fourier-transform module (e.g., 460, FIG. 4) configured to generate the first discrete transfer function by applying a discrete Fourier transform to a set of tap coefficients (e.g., one of {Cₙ}ₓₓ, {Cₙ}_{xy}, {Cₙ}_{yx}, and {Cₙ}_{yy}, FIG. 4); and the electronic filter controller is configured to generate said set of tap coefficients based on the sequence of the first sets generated by the digital processor and the sequence of the second sets generated by the first digital filter.

In some embodiments of any of the above apparatus, the electronic filter controller comprises: a first down-sampler (e.g., inserted between 410 and 430, FIG. 4) configured to down-sample the first set of digital values to generate a first down-sampled set of digital values having fewer digital values than the first set, said first down-sampled set of digital values being carried by a digital signal having a third clock rate that is smaller than the second clock rate; and a second down-sampler (e.g., inserted to replace 420, FIG. 4) configured to down-sample the second set of digital values to generate a second down-sampled set of digital values having fewer digital values than the second set, said second down-sampled set of digital values being carried by a digital signal having the third clock rate.

In some embodiments of any of the above apparatus, the first digital filter further comprises a processing module (e.g., 350, FIG. 3) configured to generate the second set of digital values by: removing from the seventh set a contiguous plurality of complex values; and decimating one of every two complex values in a remaining subset of complex values of the seventh set.

In some embodiments of any of the above apparatus, the ratio of the first clock rate to the second clock rate is a fraction M/N, where M and N are positive integers, and M>N; the first set of digital values consists of QM complex values, where QM is a positive integer; the second set of digital values consists of QN complex values, where QN is a positive integer; each of the third, fourth, and fifth sets of digital values consists of 2QM complex values; and each of the sixth and seventh sets of digital values consists of 4QN complex values.

In some embodiments of any of the above apparatus, the first discrete transfer function consists of 2QM complex values.

In some embodiments of any of the above apparatus, the transfer-function-application module is configured to generate each digital value of the fifth set by multiplying a respective digital value of the fourth set and a respective digital value of the first discrete transfer function. In some embodiments of any of the above apparatus, the digital processor further comprises one or more additional digital filters (e.g., 222₂-222₄, FIG. 2; 300, FIG. 3), each configured to perform signal-equalization and signal-interpolation processing on a respective first set (e.g., 312, FIG. 3) of digital values to generate a respective second set (e.g., 352, FIG. 3) of digital values, said respective first set of digital values being generated using the plurality of electrical digital measures and being received by the additional digital filter (e.g., via 302, FIG. 3) at the first clock rate, and said respective second set of digital values being outputted by the additional digital filter (e.g., via 362, FIG. 3) at the second clock rate.

In some embodiments of any of the above apparatus, the optical input signal is a polarization-division multiplexed signal; and the first digital filter and the one or more additional digital filters are configured to perform electronic polarization demultiplexing to enable the digital processor to recover data encoded in each of two polarization components of the optical input signal.

In some embodiments of any of the above apparatus, the first digital filter is configured to have a first transfer function (e.g., Hₓₓ, Eq. (3a) and FIG. 4); and at least one of the one or more additional digital filters is configured to have a second transfer function (e.g., one of H_{xy}, H_{yx}, and H_{yy}, Eqs. (3a)-(3b) and FIG. 4) different from the first transfer function.

According to another example embodiment disclosed above in reference to FIGS. 1-5, provided is a signal-processing method comprising the steps of: optically mixing an optical input signal (e.g., 102, FIG. 1) and an optical local-oscillator signal (e.g., 112, FIG. 1) to generate, at a first clock rate (e.g., ƒₛ, Eq. (1) and FIG. 1), a plurality of electrical digital measures (e.g., 152₁-152₄, FIG. 1) of the optical input signal; performing in a frequency domain both signal-equalization and signal-interpolation processing on a first set (e.g., 312, FIG. 3) of digital values to generate a second set (e.g., 352, FIG. 3) of digital values, said first set of digital values being generated using the plurality of electrical digital measures and being received by the digital circuit (e.g., via 302, FIG. 3) at the first clock rate, and said second set of digital values being outputted by the digital circuit (e.g., via 362, FIG. 3) at a second clock rate (e.g., ƒ₀, FIGS. 2, 3) that is smaller than the first clock rate, wherein a ratio of the first clock rate to the second clock rate is a non-integer value (e.g., M/N); and recovering data encoded in the optical input signal based on the second set of digital values.

While this disclosure includes references to illustrative embodiments, this specification is not intended to be construed in a limiting sense.

For example, although the operation of filter 300 (FIG. 3) is described above in reference to overlap module 314 that is configured to prefix additional complex values to the received set 312, embodiments of filter 300 are not so limited. Based on the provided description, one of ordinary skill in the art will understand how to modify the structure of filter 300 to enable it to operate using a suffix of additional complex values or a combination of a prefix and a suffix of additional complex values.

In some embodiments, the value of M/N may be greater than 2.

In some embodiments, the value of M/N may be expressed as K·P, where K is a positive integer greater than one, and P is a decimal fractional value smaller than one.

Although example embodiments are described above in reference to polarization de-multiplexing, filter 300 can also be used to construct an equalizer for other types of signal-equalization processing. For example, in one alternative embodiment, filter 300 can be used to construct a chromatic-dispersion compensator compatible with fractional (e.g., 1·P) oversampling instead of the conventional 2-times oversampling.

Various modifications of the described embodiments, as well as other embodiments within the scope of the disclosure, which are apparent to persons skilled in the art to which the disclosure pertains are deemed to lie within the principle and scope of the disclosure, e.g., as expressed in the following claims.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

The description and drawings merely illustrate the principles of the invention. It will thus be appreciated that those of ordinary skill in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The functions of the various elements shown in the figures, including any functional blocks labeled as “processors” and “controllers,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

What is claimed is:

1. An apparatus comprising:
an optical-to-electrical converter configured to mix an optical input signal and an optical local-oscillator signal to generate, at a first clock rate, a plurality of electrical digital measures of the optical input signal; and
a digital processor that comprises a first digital filter configured to perform, in a frequency domain, both signal-equalization and signal-interpolation processing on a first set of digital values to generate a second set of digital values, said first set of digital values being generated using the plurality of electrical digital measures and being received by the first digital filter at the first clock rate, and said second set of digital values being outputted by the first digital filter at a second clock rate that is smaller than the first clock rate, wherein:
a ratio of the first clock rate to the second clock rate is a non-integer value; and
the digital processor is configured to recover data encoded in the optical input signal based on the second set of digital values.

2. The apparatus of claim 1,
wherein the second clock rate is nominally equal to a symbol rate of the optical input signal; and
wherein the non-integer value is smaller than 2.

3. The apparatus of claim 1, wherein the non-integer value is in a range between 1.05 and 1.35.

4. The apparatus of claim 1, wherein the ratio of the first clock rate to the second clock rate is a fraction M/N, where M and N are positive integers, and M>N.

5. The apparatus of claim 4, wherein:
the first set of digital values consists of QM complex values, where QM is a positive integer; and
the second set of digital values consists of QN complex values, where QN is a positive integer.

6. The apparatus of claim 5, wherein Q is a non-integer value.

7. The apparatus of claim 1, wherein the first digital filter comprises:
a Fourier-transform module configured to apply a discrete Fourier transform to a third set of digital values to generate a fourth set of digital values, wherein the third set includes the first set;
a transfer-function-application module configured to apply a first discrete transfer function to the fourth set of digital values to generate a fifth set of digital values;
a zero-padding module configured to generate a sixth set of digital values by appending a plurality of zeros to the fifth set of digital values; and
an inverse Fourier-transform module configured to apply an inverse discrete Fourier transform to the sixth set of digital values to generate a seventh set of digital values, wherein the seventh set includes the second set.

8. The apparatus of claim 7, wherein the first digital filter further comprises an additional transfer-function-application module configured to apply another discrete transfer function to the fourth set of digital values, said another discrete transfer function being different from the first discrete transfer function.

9. The apparatus of claim 7, further comprising an electronic filter controller configured to generate the first discrete transfer function based on a sequence of first sets generated by the digital processor and a sequence of second sets generated by the first digital filter.

10. The apparatus of claim 9, wherein the electronic filter controller comprises an interpolator configured to interpolate the second set of digital values to generate a corresponding interpolated set of digital values having more digital values than the second set, said corresponding interpolated set of digital values being carried by a digital signal having the first clock rate.

11. The apparatus of claim 9,
wherein the electronic filter controller comprises a second Fourier-transform module configured to generate the first discrete transfer function by applying a discrete Fourier transform to a set of tap coefficients; and
wherein the electronic filter controller is configured to generate said set of tap coefficients based on the sequence of the first sets generated by the digital processor and the sequence of the second sets generated by the first digital filter.

12. The apparatus of claim 9, wherein the electronic filter controller comprises:
a first down-sampler configured to down-sample the first set of digital values to generate a first down-sampled set of digital values having fewer digital values than the first set, said first down-sampled set of digital values being carried by a digital signal having a third clock rate that is smaller than the second clock rate; and
a second down-sampler configured to down-sample the second set of digital values to generate a second down-sampled set of digital values having fewer digital values than the second set, said second down-sampled set of digital values being carried by a digital signal having the third clock rate.

13. The apparatus of claim 7, wherein the first digital filter further comprises a processing module configured to generate the second set of digital values by:
removing from the seventh set a contiguous plurality of complex values; and
decimating one of every two complex values in a remaining subset of complex values of the seventh set.

14. The apparatus of claim 7, wherein:
the ratio of the first clock rate to the second clock rate is a fraction M/N, where M and N are positive integers, and M>N;
the first set of digital values consists of QM complex values, where QM is a positive integer;
the second set of digital values consists of QN complex values, where QN is a positive integer;
each of the third, fourth, and fifth sets of digital values consists of 2QM complex values; and
each of the sixth and seventh sets of digital values consists of 4QN complex values.

15. The apparatus of claim 14, wherein the first discrete transfer function consists of 2QM complex values.

16. The apparatus of claim 7, wherein the transfer-function-application module is configured to generate each digital value of the fifth set by multiplying a respective digital value of the fourth set and a respective digital value of the first discrete transfer function.

17. The apparatus of claim 1, wherein the digital processor further comprises one or more additional digital filters, each configured to perform signal-equalization and signal-interpolation processing on a respective first set of digital values to generate a respective second set of digital values, said respective first set of digital values being generated using the plurality of electrical digital measures and being received by the additional digital filter at the first clock rate, and said respective second set of digital values being outputted by the additional digital filter at the second clock rate.

18. The apparatus of claim 17, wherein:
the optical input signal is a polarization-division multiplexed signal; and
the first digital filter and the one or more additional digital filters are configured to perform electronic polarization demultiplexing to enable the digital processor to recover data encoded in each of two polarization components of the optical input signal.

19. The apparatus of claim 17, wherein:
the first digital filter is configured to have a first transfer function; and
at least one of the one or more additional digital filters is configured to have a second transfer function different from the first transfer function.

20. A signal-processing method comprising:
optically mixing an optical input signal and an optical local-oscillator signal to generate, at a first clock rate, a plurality of electrical digital measures of the optical input signal;
performing in a frequency domain both signal-equalization and signal-interpolation processing on a first set of digital values to generate a second set of digital values, said first set of digital values being generated using the plurality of electrical digital measures and being received by the digital circuit at the first clock rate, and said second set of digital values being outputted by the digital circuit at a second clock rate that is smaller than the first clock rate, wherein a ratio of the first clock rate to the second clock rate is a non-integer value; and
recovering data encoded in the optical input signal based on the second set of digital values.
